(19) United States
(12) Patent Application Publication
(10) Pub. No.: US 2008/0299380 A1
(43) Pub. Date: Dec. 4, 2008

(54) Film For Packaging Of Fresh Or Fermentation Food, Packaging Material and Container

(75) Inventors: Sae Hyun Choi, Seoul (KR); Joong Cheol Lee, Incheon (KR); Woo Cheol Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: INTERPORE CO., LTD., SEOUL (KR)

(21) Appl. No.: 12/093,894

(22) PCT Filed: Apr. 20, 2006
(86) PCT No.: PCT/KR2006/001486

§ 371 Date: Jul. 22, 2008

(30) Foreign Application Priority Data
Nov. 15, 2005 (KR) 10-2005-0109236
Apr. 13, 2006 (KR) 10-2006-0033638

(51) Int. Cl. B32B 3/26

(52) U.S. Cl. 428/315.7; 428/315.5

(57) ABSTRACT

A fresh or fermentation food packaging film, a packaging material and a packaging container which use the film, are disclosed. The fresh or fermentation food packaging film whose average pore size is 0.01-2 μm and whose porosity is 10-80%, wherein the film is manufactured from pure crystalline polymer without addition of inorganic compounds or organic compounds for pore formation, so as to impart microporousness thereto by a dry stretching method which does not use an organic solvent and solvent. The packaging film which can pack fermentation food, such as Kimchi, etc., and fresh food, such as vegetables, etc., in which the packaging film can allow the food some operations, such as breathing and transpiration, etc., but restrain penetration of liquid, such as, water, etc., and can also effectively prevent leakage of smell, such that the food can be kept fresh, through a simple handling process.

### TECHNICAL FIELD

The present invention relates to a film for packaging fresh food or fermentation food, a packaging material and a packaging container, which are manufactured by the film, and more particularly to a packaging film which can pack fermentation food, such as Kimchi, etc., and fresh food, such as vegetables, etc., in which the packaging film can allow the food some operations, such as breathing and transpiration, etc., but restrain penetration of liquid, such as, water, etc., and can also effectively prevent leakage of smell, such that the food can be kept fresh, and a packaging material and a packaging container which use the film, through a simple handling process.

### BACKGROUND ART

When fermentation food, such as Kimchi, thick soypaste mixed with red peppers (Gochujang in Korean), fermented soybean paste (Doenjang in Korean), and salted seafood (Jeotgal in Korean), or fresh food, such as vegetables, or meat, etc., are packed in a package, gases, such as CO₂, etc., are generated in the package as the foods are continuously breathing. Generation of gases causes expansion or damage of the package, decreases appearance and also decreases freshness of food.

In order to prevent such problems, there has been used a conventional chemical method in which a small package including freshness maintaining material (or gas absorption materials) is sealed in a package in which food is included, such that gases in the food package can be absorbed or adsorbed. Here, the freshness maintaining material (or gas absorption materials) depends on kinds of foods.

Also, there has been used a conventional physical method in which a surface of a package is penetrated by a laser or a gas exhaust hole of a proper size is formed on the surfaces of the package so as to weld a one way valve to inside and outside of the gas exhausted hole, such that gas can be exhausted from the inside to the outside of the package when the gas pressure reaches a predetermined value. Therefore, the conventional physical method can allow the package to enhance the value of goods and to prolong storage duration of the foods.

However, in a case where such freshness maintaining material packed as a small package is inserted and sealed, together with food, in a food package, when the food package is opened, the freshness maintaining material located on the food may decrease taste of the food or, when the small package is damaged, the freshness maintaining material may flow out to the food. Also, the attaching process of the small package makes the entire process complicated and inefficient.

Also, when a film is penetrated by a laser to form gas hole therein, there are many problems, for example, a liquid material, etc., flows out to form a smear around the gas hole.

More specifically, there are conventional methods for discharging gases from food packages. Fermented food, such as Kimchi, is packed in packages in which gas absorption material (Ca(OH)₂) is inserted or in which an air vent is installed. Fruits are packed in packages in which small holes are physically penetrated. Fresh vegetables are packed in packages in which micro holes are penetrated by a laser. Rice or unpolished rice, and grains are packed in packages in which small holes are physically penetrated.

However, in a case where the gas absorption material (Ca(OH)₂) is used for Kimchi to absorb CO₂ gas, since it is in direct contact with the Kimchi, it may decrease appearance of the Kimchi that is obvious when the package is opened. Also, when the package for the gas absorption material (Ca(OH)₂) is damaged, the material may flow out to the Kimchi. Therefore, in order to prevent such problems, the package for the gas absorption material requires additional manual processes. Also, the material is packed using a small package, the amount of gas absorption material is increased in proportion to the volume of food to be packed in a food package. Also, when tiny food particles are inserted in the gas exhaust hole of a food package, the physical penetration method or gas exhausting valve installation method causes damage of the food package due to expansion pressure of the food package.

Also, in a case where fruits or vegetables are packed in packages on which small holes are formed by punching or a laser, since the diameters of the small holes are in a range of a few mm to at least 0.1 mm, the packages cannot be waterproof but instead air can flow from inside to outside and vice versa. However, the packages have disadvantages in that air-permeability cannot be properly controlled according to amount of food breathing and foreign matter can flow inward.

In addition, in a case where rice and grains are packed by packages in which small holes are formed to enhance storage thereof and to exhaust gases produced when the rice and grains are filled in the package, the packages have disadvantages in that they allow air to bi-directionally flow, are not waterproof, and cannot prevent inflow of bugs and foreign matter.

On the other hand, a packaging container for fermentation food is disclosed in Korean Patent laid-open No. 10-2002-000524, in which the opening of the package container is sealed by a film of compound material having air-permeability which shields light, which is capable of guaranteeing breathing of fermentation food. Here, the film is made of polymer whose melting point is below 300° C. More specifically, the film is formed such that: a polyolefin group polymer is mixed with one or more than one inorganic compound selected from among sericite, antibacterial ceramic, CaCO₃, Ba₂SO₄, SiO₂, and Talc; and then the result is drawn. As such, when the film is manufactured using the inorganic compounds, the film has porousness such that water cannot be leaked. However, when such film is used as a package for fermentation food, it can allow gases to discharge from the inside to the outside.

However, when pores are formed in the film by addition of inorganic compounds, the added inorganic compounds may ooze to the food. Since, as shown in FIG. 2, the pore is shaped as a structure penetrating the film, the film can allow gases and smell of the food, etc., to leak. Therefore, the film is not preferable for storage and distribution of food.

Therefore, there is need of a package which can allow the food some operations, such as breathing and transpiration, etc., but restrain penetration of liquid, such as, water, etc., and can also effectively prevent leakage of smell, such that the food can be kept fresh, through a simple handling process.

### DISCLOSURE

### Technical Problem

Therefore, the present invention has been made in view of the above problems, and it is an object of the present invention to provide a film for packing fresh food or fermentation food which is capable of keeping freshness of fresh food or fermentation food, when the film, which has been used for a battery separator, a filter membrane, a separator membrane, a gas exchange membrane, etc., has a certain porosity and a certain pore size.

It is another object of the present invention to provide a film for packing fresh food or fermentation food, in which the film used for a battery separator is manufactured so as to impart microporousness thereto by a dry stretching process.

It is further another object of the present invention to provide a film for packing fresh food or fermentation food, in which the film used for a battery separator is manufactured so as to impart microporousness thereto by a dry stretching process, such that it cannot discharge smell but enhances gas discharge performance or liquid impermeability, compared with a stretching film to which microporousness is imparted as inorganic compounds, etc., are added thereto.

It is still another object of the present invention to provide a film for packing fresh food or fermentation food, which can be adapted to a part of a general package to form a window of the general package, such that gases in the general package can be remarkably discharged.

It is still further another object of the present invention to provide new use of a film, which has been used for a battery separator, a filter membrane, a separator membrane, a gas exchange membrane, etc., in which the film is manufactured from only a pure resin component without addition of inorganic compounds or organic compounds for pore formation, using a dry stretching method. Here, the new use of a film is indicative of use for packing fresh food, such as, vegetables, fruits, meats, or fermentation food, such as, Kimchi, salted seafood (Jeotgal in Korean), all kinds of fermented paste (Jangs in Korean).

It is yet another object of the present invention to provide a film for packing fresh food or fermentation food, which can allow the food some operations, such as breathing and transpiration, etc., but restrain penetration of liquid, such as, water, etc., and can also effectively prevent leakage of smell, such that the food can be kept flesh, through a simple handling process.

### Technical Solution

In accordance with a first aspect of the present invention, the above and other objects can be accomplished by the provision of a fresh or fermentation food packaging film whose average pore size is 0.01˜2 μm and whose porosity is 10˜80%, wherein the film is manufactured from pure crystalline polymer without addition of inorganic compounds or organic compounds for pore formation, so as to impart microporousness thereto by a dry stretching method which does not use an organic solvent and a solvent.

Preferably, the film is 15˜200 μm in thickness.

Preferably, the film is manufactured by the steps of: manufacturing an unstretched film as the pure crystalline polymer is extruded without addition of inorganic and organic particles, such as stabilizer, antioxidant, or dispersant; crystallizing the unstretched film by cooling and forming fibrous pores by a physical stretching process; and performing a heat process.

Preferably, the crystalline polymer is one or more than one polyolefin group resin selected among from high-density polyethylene (HDPE), low-density polyethylene (LDPE), linear low-density polyethylene (LLDPE), high molecular weight polyethylene (HMW-PE), ultra high molecular weight polyethylene (UHMW-PE) and polypropylene (PP).

In accordance with a second aspect of the present invention, there is provided to a polyolefin group film for packaging fresh or fermentation food, which is manufactured as parts of the fresh or fermentation food packaging film according to the first aspect are stuck to each other by heat.

In accordance with a third aspect of the present invention, there is provided to a package for packaging fresh or fermentation food, wherein the package includes at least one or more than one layer of the fresh or fermentation food packaging film according to the first aspect.

In accordance with a fourth aspect of the present invention, there is provided to a package for packaging fresh or fermentation food, wherein the package includes at least one or more than one layer of the polyolefin group film according to the second aspect.

In accordance with a fifth aspect of the present invention, there is provided to a container for packaging fresh or fermentation food, wherein the container is formed as the fresh or fermentation food packaging film according to the first aspect is adapted to a lid.

In accordance with a sixth aspect of the present invention, there is provided to a container for packaging fresh or fermentation food, wherein the container is formed as the polyolefin group film according to the second aspect is adapted to a lid.

### ADVANTAGEOUS EFFECTS

When fresh or fermentation food packaging film according to the present invention is used for a package for packaging fermentation food, such as Kimchi, etc., or fresh food, such as vegetables, in which the film, which has average pore size of 0.01˜2 μm and porosity of 10˜80%, is manufactured from pure crystalline polymer without addition of inorganic compounds or organic compounds for pore formation, so as to impart microporousness thereto by a dry stretching process, the film has advantages in that, while it allows gases generated as foods breathes, etc., to be effectively discharged from the inside of the package to the outside, it prevents liquid, etc., included in the package from leaking and smell from flowing out, such that food can maintain its freshness for a relatively long term and rarely change its taste although the food is stored for a relatively long time. Especially, although the film according to the present invention is adapted to form a package or a part of package, since the effects are the same therebetween, it is a remarkable alternative to replace the conventional packages. Namely, the film according to the present invention can replace the convention packages one of which includes a gas absorption material and another of which has holes which are penetrated by laser. Especially, the film according to the present invention can prolong storage duration of fresh vegetables whose storage durations are relatively short, such as broccoli, and prevent a nasty smell from being generated while the food is stored, thereby creating high-added value.

### DESCRIPTION OF DRAWINGS

The above and other objects, features and other advantages of the present invention will be more clearly understood from the following detailed description taken in conjunction with the accompanying drawings, in which:

FIG. 1 is a photograph of a film according to through SEM, in which the film is obtained from a pure crystalline polymer, using a dry stretching method, without addition of inorganic compounds or organic compounds;

FIG. 2 is a photograph of a film which is obtained from polymer including calcium carbonate and barium sulfate particles, through a stretching process;

FIG. 3 is a photograph of an individual of broccoli which is unit packaged for storage experiment of the broccoli, according to experiment 4;

FIG. 4 is a graph measuring hue angle according to broccoli storage duration;

FIG. 5 is a graph measuring weight loss according to broccoli storage duration;

FIG. 6 is a graph measuring amount of O₂ gas in the package according to broccoli storage duration; and

FIG. 7 is a graph measuring amount of CO₂ gas in the package according to broccoli storage duration.

### BEST MODE

Now, preferred embodiments of the present invention will be described in detail with reference to the annexed drawings.

Microporous films are widely used in a various fields, for example, air rectification, a filter for water processing, etc., a separator for electrolysis or a battery, etc., a gas exchange film, artificial organs, beverage purification, or enzyme purification, etc.

Especially, methods for manufacturing a microporous film used as a separator are mainly classified into dry stretching and wet stretching. Since the dry stretching method allows a film to be manufactured with a wide width, and requires only simple processes, but does not use organic solvent, it has advantages in that its superior manufacturing environments can be provided and mass production can be easily performed, compared with other methods.

Embodiments for manufacturing microporous films using the dry stretching are disclosed in U.S. Pat. Nos. 3,679,538, 3,801,692, 3,843,761, 4,238,459, and 5,013,439, etc. Continuous cold stretching and hot stretching are included.

In such a dry stretching method which manufactures a separator using crystalline polymer, pores are formed as a relatively weak amorphous region is broken through the cold stretching. Since the method uses only pure polymer, it has advantages in that it is clean process which never causes environment pollution problems due to use of organic solvent and solvent.

The present invention develops new use of a film for a separator, which is obtained by use of the dry stretching. Namely, the present invention has advantages in that, since the film manufactured using the dry stretching does not use the organic solvent and solvent, although it is used for a package for food, deterioration of food can be reduced.

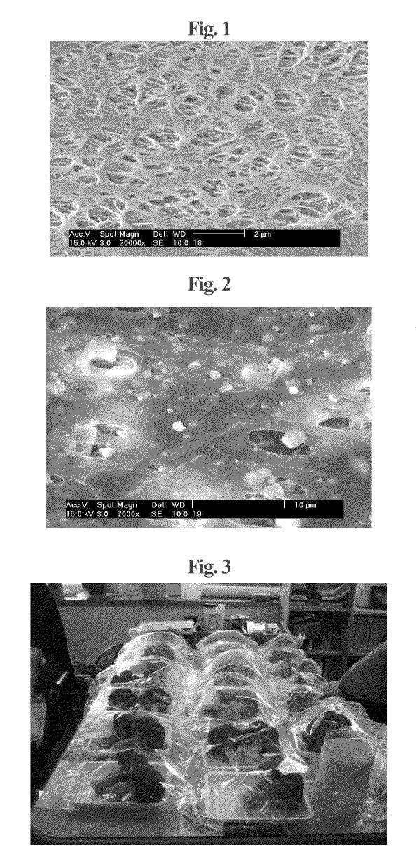

On the other hand, a film having microporosity by the dry stretching method has a pore structure as shown in FIG. 1. Namely, since the film has a structure of multiple layer films which are cubicly folded and have micro air hole paths, when the film is used for a package for food, it can prevent smell of food in the package from flowing out but allow gases, such as CO₂ gas, etc., which are generated as food breathes or ferments, to easily flow out from the inside of the package. Especially, since the package does not discharge all of the CO₂ gas generated from the food therein but discharges the CO₂ gas therefrom such that a certain amount of CO₂ gas can be maintained therein, when it is used to pack food, such as Kimchi, etc., it can allow tissue of Kimchi to remain crunchy. Generally, feeling fresh taste of Kimchi is dependent on the degree of crunch of tissue of the Kimchi, which is affected by remaining CO₂ gas in the package, and is well known. Also, since the film according to the present invention has such a pore structure, it can prevent liquid material from leaking. However, in order to completely achieve the objective of the present invention, the film is not suitable by only adopting microporosity using a dry stretching. Preferably, the film has porosity of 10˜80% and an average pore size of 0.01˜2 μm. More preferably, the film is implemented such that the porosity is 30˜70% and the average pore size is approximately 0.2 μm.

When the film whose porosity is less than 10% is used for a package for food, since the discharge rate of the food breathing and the generation gas is low, the package can be expanded such that it can be broken. On the other hand, as for the film whose porosity is greater than 80%, the film cannot properly function as a package while maintaining a required mechanical strength. Also, when the film whose average pore size is smaller than 0.01 μm is used for a package for food, it can be expanded to the point of breaking due to gas generation. On the other hand, as for the film whose average pore size is greater than 2 μm contents in the package can be leaked according to kinds of liquids.

As such, so that the film is manufactured using a dry stretching method while satisfying the porosity and pore size, an unstretched film is firstly manufactured as a pure polymer is extruded without addition of inorganic compound or organic compound particles, such as stabilizer, antioxidant or dispersant. Afterwards, the result is crystallized by cooling, such that fibrous pores are formed between Lamella stacks as crystal portions, as physical stretching processes are applied to amorphous portions several times. After that, the result is processed by heat such that microporous film is produced as a final product. Here, the crystalline polymer is a polyolefin group resin. More specifically, the crystalline polymer is one or more than one polyolefin group resin selected among from high-density polyethylene (HDPE), low-density polyethylene (LDPE), linear low-density polyethylene (LLDPE), high molecular weight polyethylene (HMW-PE), ultra high molecular weight polyethylene (UHMW-PE) and polypropylene (PP).

More specifically, the following is a description for a method for manufacturing a microporous film. Firstly, an unstretched film is manufactured as crystalline polymer used as low temperature material is extruded by an extruder to which T-die or tubular die are attached. Afterwards, in order to increase crystallinity and elastic restoration rate, the unstretched film is processed by annealing in a dry oven below a temperature of melting point of polymer. The annealed film is stretched below room temperature using a stretching device such that micro cracks can be formed in the stretched film. After that, the micro cracks, which are formed by the low temperature stretching device, etc, are stretched below a temperature of melting point of polymer using the stretching device such that the micro cracks can be changed to micro pores having a certain size, thereby allowing the film to have appropriate mechanical properties. After hot stretching is completed, the film is heat setting for a certain time below a temperature of melting point of polymer, while tension is applied thereto.

The above description is related to a general method for forming a microporous film. Here, the method can be implemented such that some steps are omitted or added therefrom/thereto, depending on a porosity or a pore size, etc., which are required factors when the film is used for a package for food. Also, the method can be implemented such that the sequence of the steps is changed.

On the other hand, although the film is manufactured using the dry stretching, when the film forms pores, not through stretching but through inorganic compounds or organic compounds, such as calcium carbonate and barium sulfate, etc., such film has a pore structure as shown in FIG. 2.

As shown in the photograph of SEM in FIG. 2, when the pore is formed in the film using general inorganic compounds or organic compounds, the pore structure is formed such that the pore penetrates the film, unlike the pore structure of FIG. 1. Therefore, some pores can discharge CO₂ gas from the inside of the package, according to their sizes. However, other pores cannot discharge CO₂ gas such that a certain amount of CO₂ gas remains, thereby leaking smell, etc., generated in the package, from the package. Therefore, the film cannot completely prevent leakage of liquid.

On the other hand, the film used for a package for food according to the present invention is preferably implemented such that its thickness is 15˜100 μm, considering its strength, etc. However, it will be easily appreciated that the thickness of the film can be properly adjusted, considering weight of product to be packed, etc.

Also, preferably, the tensile strength of the film, for example, tensile strength of machine direction, is 1000˜2000 kg/cm², and heat shrinkage rate is ±0%˜±2%. In addition, the pore shut-down temperature is preferably 110˜170° C. Therefore, when the film is used for a package for food, pore shut-down does not occur at the temperature and thus its function, such as, gas permeability, etc., must not be decreased.

The film used for a package for food according to the present invention can be used such that a pack of food can be entirely packed thereby and also used for a cover of a container.

Also, although the film according to the present invention can replace only a relatively small part of a package for food, the objective of the present invention can be achieved. Namely, when a general polyolefin group film, etc., which is used as a general food packaging film, is manufactured, a part of the general film is replaced with the microporous film according to the present invention and then bound to each other by heating. Therefore, a polyolefin group film to which the film according to the present invention is locally applied can be manufactured so as to pack food.

Further more, the film according to the present invention can be implemented such that at least more than one layer of the film are bound with other film or non-woven cloth, etc. to form a package. Also, the film according to the present invention can replace only a part of a general film to form a partial replacement film such that at least more than one layer of the partial replacement film are bound with other film or non-woven cloth, etc. to form a package.

For example, a package of Kimchi, which has been sold on the market, is made of polypropylene, polyethylene, nylon, polyester, low-density polyethylene (LDPE), and linear low-density polyethylene (LLDPE). The film of the present invention is cut at a certain size, and then a top film part of a package which corresponds to the size is exfoliated. After that, the microporous film of the present invention is attached to the exfoliated result by heating and then sealed. Here, the microporous film of the present invention can be attached thereto with a single layer. Also, the microporous film can be bound with non-woven cloth such as polypropylene, polyester, etc., to increase binding efficiency and then bound by heating. Therefore, there is no difficulty to manufacture a package from the microporous film of the present invention. Also, since the processes are collectively performed while the package is manufactured, its manufacturing processes can be normally performed. When air-permeability is imparted to the film by the above-described method, the film of the present invention can be easily manufactured compared with the method in which the gas absorption matter which is well-known in the food packaging fields is additionally attached to the package and then sealed, and is safe because there is no risk that the gas absorption material is flown out.

The application of the film of the present invention is not limited by the package for Kimchi. Namely, the film of the present invention can pack fresh vegetables. The microporous film of the present invention can be applied to a relatively small part of a package for rice or unpolished rice such that air-permeability can be imparted to the package.

Especially, regarding fresh vegetables, such as broccoli, whose storage duration is relatively short such that their distribution efficiency can decrease, the film of the present invention can prolong its storage duration more than two times compared with a conventional polyethylene group package. Also, although such fresh vegetables are preserved in the film of the present invention, the film can prevent bad smell such that value of goods can be kept.

The following is a description of a method for manufacturing microporous film which has been used as a separator membrane. A test is performed as to air-permeability which is suitable for a food package, and as to no-leakage, and no-smell leakage, etc. Also, taste estimation is performed as to whether taste is changed when the food is stored. Although storage of broccoli as a fresh vegetable is used as an example, these embodiments do not limit the scope of the present invention.

### EXAMPLE 1

Under conditions in which transfer temperature is 190° C. and discharge speed is 30 m/min, inflation film made of polypropylene (UBE-PP-F109K which is a trademark, Ube Industries, Ltd.; melt index=9 g/10 min) is acquired, using inflation molder having a die whose outer diameter is 150 mm. The acquired polypropylene film is heated at 145° C. for 30 min to obtain an unstretched film whose crystallinity is 70%.

The unstretched film is stretched in liquid nitrogen (−196° C.) gas such that its length is increased 20% longer than its initial length. Continuously, the film is heat set for 2 nm in at 145° C. while maintaining the stretched state.

Afterwards, the film is processed by 300% hot stretching at 130° C. Additionally, the film is heat set at 145° C. for 30 min so as to obtain a polypropylene microporous film.

The obtained film is measured with respect to average pore size, porosity, thickness, gas permeability, tensile strength, heat shrinkage, and pore shut-down temperature, as described in Table 1.

Here, the pore size and porosity are measured by a Mercury porosimetry (AutoPoreIV9500), and the thickness is measured by a micrometer. The gas permeability is measured by a method in which nitrogen gas and O₂ gas are adsorbed. Also, the tensile strength is measured by ASTM D638, and the heat shrinkage rate is measured by ASTM D1204. Further, the pore shut-down temperature is measured by a DSC analysis. The Mercury porosimetry serves to measure the pore size and porosity as Mercury is permeated into the pore to measure its volume, in which the measurement value can be calculated by following Equation (1).

PD=−4γ cos ∂ (1)

Where, P and D denote an applied pressure and a diameter, respectively. γ denotes a surface tension of mercury (480 dyne/cm), and θ denotes a contact angle (140°) between mercury and pore wall.

### EXAMPLE 2

Crystalline polypropylene, whose density is 0.92 and whose melt index is 0.6 g/10 min, is melted and extruded through a die of 4 inches, whose discharge hole diameter is 0.04 inch. Afterwards, the extruded result is cooled so as to obtain an unstretched film.

The extruded film is stretched by 10% at room temperature and then stretched by 10% at −20° C. After that, the result is processed by a hot stretching at 140° C. Afterwards, the film is heat set for 10 min at 140° C.

The obtained film is tested through the method performed in Example 1, so as to obtain its various characteristics which are described in Table 1.

### EXAMPLE 3

Crystalline polyethylene, whose density is 0.93˜0.96 and whose melt index is 0.5˜1.2 g/10 min, is melted and extruded through a die of 4 inches, whose discharge hole diameter is 0.04 inch.

The extruded film is processed by a cold stretching at 25° C., such that its length can be increased by 50% more than its original length. After that, the result is processed by a hot stretching at 115° C. Afterwards, the film is heat set for 5 min at 120° C.

The obtained film is tested through the method performed in Example 1, so as to obtain its various characteristics which are described in Table 1.

### EXAMPLE 4

An inflation film of HDPE (which is named as HIVOREX, Honam Petrochemical Corp., melting index of 0.5˜1.2 g/10 min and density of 0.93˜0.96) is obtained, using an inflation molder having a die whose outer diameter is 150 nm u, under a transfer temperature of 190° C. and a discharge speed of 30 m/min. The obtained HDPE film is processed by annealing for 90 min at 126° C. so as to obtain an unstretched film whose crystallinity is approximately 70%.

The unstretched film is cooled and then stretched using a stretching roll such that its length is increased by 50% more than its original length. Continuously, the film is processed by 300% heat stretching at 110° C. while the film undergoes the stretching state, and then heat set for 5 min.

The obtained film is tested through the method performed in Example 1, so as to obtain its various characteristics which are described in Table 1.

### EXAMPLE 5

An inflation film of BMW-PE (which is named as GHR, Ticona GmBh, melt index of 1.2 g/10 min, and molecular weight of 6.0×10⁵ g/mol) is obtained, using an inflation molder having a die whose outer diameter is 150 mm, under a transfer temperature of 190° C. and a discharge speed of 30 m/min.

Before the HMW-PE is applied to the inflation molder, it is mixed with mineral oil at a 15% weight ratio, using a planetary mixer, at relatively high temperature which is less than its melting temperature, so as to form pellet and to be manufactured in an extruder.

The obtained HMW-PE film is processed by annealing for 90 min at 126° C. so as to obtain an unstretched film whose crystallinity is approximately 50%.

The unstretched film is cooled in liquid nitrogen (−196° C.) such that its length is increased by 50% more than its original length. Continuously, the film is processed by 300% heat stretching at 110° C. while the film undergoes the stretching state, and then heat set for 5 min.

The obtained film is tested through the method performed in Example 1, so as to obtain its various characteristics which are described in Table 1.

### COMPARISON EXAMPLE 1

Compounds, which are composed of polyester, CaCO₃ of 45 wt. % and BaSO₄ of 10 wt. %, are melted in extruders which are aligned, on the basis of four steps, 210° C., 230° C., 250° C. and 250° C. From the result, a film of 100 μm is obtained through a T-die, and then stretched in the machine direction to twice the length to obtain a film.

The obtained film is tested through the method performed hi Example 1, so as to obtain its various characteristics which are described in Table 1.

TABLE 1

| | | | | | | | Comparison | |
|---|---|---|---|---|---|---|---|---|
| | | Examples | | | | | examples | |
| | | 1 | 2 | 3 | 4 | 5 | 1 | 2* |
| Pore size (μm) | | 0.13 | 0.12 | 0.15 | 0.15 | 0.10 | 500 | 500 |
| Porosity (%) | | 71.0 | 37 | 52 | 55 | 32 | 0.3 | 0.2 |
| Thickness (μm) | | 25 | 25 | 25 | 45 | 30 | 350 | 400 |
| Gas permeability | | 1600 | 680 | 1500 | 1450 | 800 | — | — |
| (cc/cm² min) | | | | | | | | |
| Tensile strength | Machine direction (MD) | 1100 | 1300 | 1800 | 1800 | 2300 | 2200 | 2200 |
| (kg/cm²) | Transverse | 110 | 130 | 220 | 250 | 850 | 2200 | 2200 |
| | direction (TD) | | | | | | | |

| | | | | | | | |
|---|---|---|---|---|---|---|---|
| Heat shrinkage rate (%) | >2 | >2 | >2 | >2 | >2 | >3 | >3 |
| Pore shut-down temperature (° C.) | 163 | 163 | 134 | 135 | 135 | — | — |

*comparison example 2: a film manufactured as a polypropylene film is penetrated by a laser

### EXPERIMENTAL EXAMPLE 1

The microporous films of Example 4 and Comparison example 1 are taken by an SEM (a Philips XL302SEM), to identify pore structures.

The results are shown in FIG. 1 and FIG. 2.

As shown in FIG. 1, the film of Example 4 forms a plurality of pores through a dry stretching method without addition of inorganic compounds or organic compounds, in which the plurality of pores are densely formed and mutually connected to each other. On the other hand, when the pores are formed using inorganic compounds or organic compounds, the film has a pore structure such that holes are simply formed therein, as shown in FIG. 2,

### EXPERIMENTAL EXAMPLE 2

A container for packaging fermentation food is manufactured using the films of Examples 1 to 5 and Comparison examples 1 to 2. Here, the packaging container is shaped as the conventional container for packaging Kimchi, which is presently used on the market. Each film is adapted to the cover part of each container.

The container is made of polypropylene resin. After 80 g of newly prepared Kimchi is put into the container, the opening of the container is sealed by each of the films of the Example and Comparison example, using a hot melt adhesives.

Regarding each sample, in order to accelerate generation of CO₂ gas by aging, the sample is aged for 15 days at a relatively low temperature, preferably, below 10° C., then a state is observed with naked-eye as to whether a top film sealing the container is swollen by pressure of gases generated in the container. Here, the low temperature aging method is performed, considering preparing Kimchi and distributing the prepared Kimchi while it is cold-stored. Also, another observation is performed as to whether liquid is leaked from the inside. In addition, a further observation is performed as to whether Kimchi smell is released from the product. When the result is measured, the case (Comparison example 2), in which laser penetration is performed, is excluded from the result, because a laser-penetrated packaging container is not suitable for a general Kimchi packaging container.

The result is described in Table 2.

TABLE 2

| | | | | | | Comparison |
|---|---|---|---|---|---|---|
| | Examples | | | | | example |
| | 1 | 2 | 3 | 4 | 5 | 1 |
| Generation | Non | Non | Non | Non | Non | Non |
| of Swelling | | | | | | |
| Liquid leakage | Non | Non | Non | Non | Non | Some |
| Smell leakage | Non | Non | Non | Non | Non | done |

On the other hand, after Kimchi is aged in the package, the package is opened such that the Kimchi can undergo a sensory test. The sensory test is performed by 20 members who are specially trained therefor, such that they can perform comparison therebetween and estimate quality of the Kimchi based on five-point scale (5: Excellent, 3: good, and 1: Very bad). Especially, the sensory test is performed, in relation to the degree of feeling of fresh taste of Kimchi, while tissue of Kimchi is crunchy. The comparison example 1 is compared to a control.

The result is described in Table 3.

TABLE 3

| Classification | Total preference |
|---|---|
| control (comparison example 1) | 2.78 |
| Example 1 | 3.69 |
| Example 2 | 3.25 |
| Example 3 | 3.65 |
| Example 4 | 3.34 |
| Example 5 | 3.73 |

On the other hand, evaporation ratio of moisture in the product is measured immediately after the product is sealed and after aging is performed as the above-listed periods have lapsed. Such measurement is performed such that an initial weight of the product is firstly measured immediately after the product is sealed; then later weight of the product is re-measured after aging periods have lapsed; and the variation of the weight is calculated on the basis of percentage. As a result, the products of Examples 1 to 5 show that their moisture evaporation ratios are less than 0.4%, which indicates that CO₂ gas is smoothly discharged but the moisture is not discharged therefrom. Such a result is caused by the pore structure of the film according to the present invention.

### EXPERIMENTAL EXAMPLE 3

A product for packaging Kimchi is manufactured as the shape of the container of the experimental example 2. Here, so that the top film cannot be not entirely used by each of the films of examples 1 to 5, the films of examples 1 to 5 are cut by 30 mm in width and 30 mm in length such, respectively.

A part of a polypropylene film, which has been generally used for a top film of a Kimchi package, is exfoliated such that the exfoliated part can be thermally attached to the cut microporous film. The result is used as the top film for the Kimchi container, and then a test is performed for the container, as the experimental example 2.

The result is described in Table 4.

TABLE 4

| | Examples (partial application) | | | | |
|---|---|---|---|---|---|
| | 1 | 2 | 3 | 4 | 5 |
| Generation of Swelling | Non | Non | Non | Non | Non |
| Liquid leakage | Non | Non | Non | Non | Non |
| Smell leakage | Non | Non | Non | Non | Non |

On the other hand, after the Kimchi is aged in the package, the package is opened such that a sensory test is performed to test taste of the Kimchi, etc., through the method of the experimental example 3. The result is described in Table 5.

TABLE 5

| Classification | Total preference |
|---|---|
| control (Comparison example 1) | 2.78 |
| Example 1 (Partial application) | 3.68 |
| Example 2 (Partial application) | 3.23 |
| Example 3 (Partial application) | 3.63 |
| Example 4 (Partial application) | 3.33 |
| Example 5 (Partial application) | 3.71 |

On the other hand, like the experimental example 2, when moisture evaporation ratio is measured for the product in which the each of the films of examples 1 to 5 is partially used, it is less than 0.4%.

### EXPERIMENTAL EXAMPLE 4

In order to confirm as to whether the film according to the present invention enhances storage of fresh vegetables, a test for the film is performed for a broccoli as a kind of fresh vegetable at the National Horticultural Research Institute of the Rural Development Administration in the R. O. K.

More specifically, the species of broccoli for the test is green product. Such broccoli is packed by a package, on the basis of 250˜300 g as shown in FIG. 3. Here, the package is manufactured by a polyethylene group film whose thickness is 0.03 mm, which is generally used in the market. Here, the package formed by only the polyethylene group film is called ‘control.’ On the other hand, a package forms a hole of 1 mm around which each of the films of examples 1 to 5 is attached as a sticker, in which the attached film is cut by 3.3×3.3 mm as standard, or standard 3.3×3.3 mm. Namely, such a package with a sticker type of film is an embodiment of the present invention. Here, the sticker type of film indicates a product which is manufactured such that the edges of the microporous film having the standard size are coated with a hot melt adhesives which can perform heat adhesion, and then a releasing film is laminated with the edge through the adhesives. When the microporous film is laminated with parts around a punched hole of a polyethylene film used as a general package, the releasing film is removed therefrom and then the micro film is thermally laminated therewith, thereby easily manufacturing a package.

The number of each individual for the test is calculated on the basis of ratio in which the untreated control, for example, is 50:50, such that the test can be performed for films of a total of 60 packages.

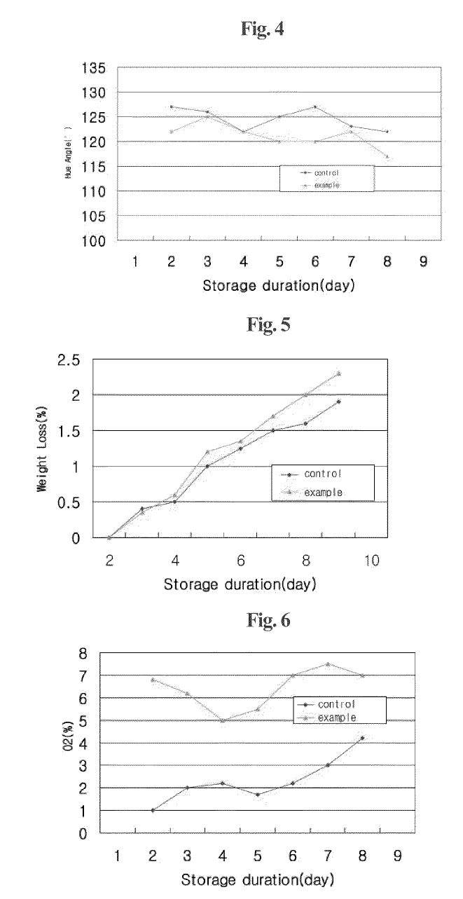

The test is performed for 8 days at room temperature. During the test, hue, weight (moisture) reduction rate, amount of O₂ gas hi the package and amount of CO₂ gas are measured at the same time each day. The measured results are illustrated through FIG. 4 to FIG. 7.

The hue is measured by a colorimetry. The weight (moisture) reduction rate is measured as change of weight of each package is measured at the same time each day. Also, the amount of O₂ gas and the amount of CO₂ gas are measured by a gas chromatography in which a needle is inserted into the package to collect gases in the package.

From FIG. 4 showing hue measurement result, both of the package (the present invention) to which the microporous film according to the present invention is applied and the general polyethylene film package (untreated control example) show a hue angle between 110˜130°, in which value of the broccoli is effective. The broccoli whose color is normally green is changed to brown when the hue angle is less than 110°.

Also, from FIG. 5 showing the result of measuring weight change, both of the package to which the microporous film according to the present invention is applied and the general polyethylene film package show that moisture is lost as storage duration elapses.

FIG. 6 is a graph measuring amount of O₂ gas in the package according to broccoli storage duration. In a case where the microporous film according to the present invention is used for a package, since the package can breathe, the large amount of O₂ gas can exist therein, comparing with the general package manufactured by the polyethylene film.

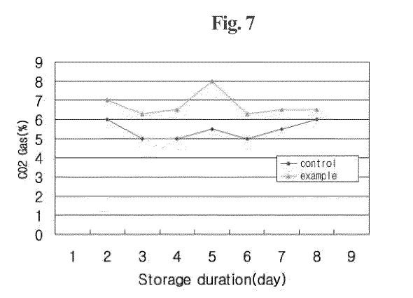

FIG. 7 is a graph measuring amount of CO₂ gas in the package according to broccoli storage duration. The package manufactured using the film according to the present invention can allow a large amount of CO₂ gas to be generated therein, compared with the general package manufactured by the polyethylene film. This is because the package of the present invention allows a large amount of O₂ gas to be permeated therein. However, when the result of FIG. 7 is compared with that of FIG. 6, it shows that the general package manufactured by the polyethylene film includes relatively small amount of O₂ gas but relatively large amount of CO₂ gas. Therefore, it can be appreciated that the CO₂ gas, which are generated as the broccoli transpires, are not properly discharged from the inside of the package.

In addition, a state as to whether nasty smell of broccoli is generated and the degree of decay due to mildew and bacteria are checked. After that the results are shown through following Tables 6 and 7. Here, the state and the degree of the decay are main factors to affect value of fresh vegetables. Here, the state as to whether nasty smell is generated is measured by a sensory test. When some sort of nasty smell of broccoli is smelled together with inherent smell of the broccoli, such a state is indicated by “+” in the Table. When the nasty smell is more smell, such a state is indicated by “++” in the Table. In addition, when the nasty smell is serious, such a state is indicated by “+++” in the Table. On the other hand, the degree of decay is observed with naked-eye as to whether the broccoli is changed to black.

TABLE 6

| Storage | Packaging using general | | Packaging using films | |
|---|---|---|---|---|
| duration | polyethylene film | | of present invention | |
| (day) | Upon opening | After 10 min | Upon opening | After 10 min |
| 2 | + | + | No smell | No smell |
| 3 | + | + | No smell | No smell |
| 4 | ++ | ++ | No smell | No smell |
| 6 | ++ | ++ | No smell | No smell |
| 7 | +++ | +++ | No smell | No smell |
| 8 | +++ | +++ | No smell | No smell |

TABLE 7

| Storage duration | Packaging using | Packaging using films of |
|---|---|---|
| (day) | general polyethylene film | present invention |
| 2 | Non | Non |
| 3 | Non | Non |
| 4 | Non | Non |
| 6 | Non | Non |
| 7 | Non | Non |
| 8 | + | + |

From the result of Table 6, it is appreciated that the package manufactured by the film of the present invention does not allow generation of nasty smells until storage duration lapses 8 days, but the package manufactured by the general polyethylene film allows generation of a nasty smell after 2 days elapse, somewhat more nasty smell after 4 days elapse, and much more nasty smell after 7 days such that the broccoli has no value.

From the results of Tables 6 and 7, decay is not observed in both of the control and the package of the present invention, with respect to their appearance, but it is appreciated that the untreated control example is substantially decayed such that it has little value. Such result is produced as the broccoli is not allowed to smoothly breathe in the untreated control example.

Table 7 shows the result of observation of appearance decay, it is appreciated that both cases show the same phases.

Consequently, from the results of FIG. 4 to FIG. 7 and the results of Table 6 and Table 7, when the broccoli is stored by only the package manufactured by the general polyethylene group film, the storage duration is at most 3 days. On the other hand, when the broccoli is stored by a package a part of which is replaced with the film of the present invention, the storage duration is prolonged by 6 to 7 days. Therefore, the present invention can remarkably prolong the storage duration of broccoli whose storage duration is relatively short.

Although the experimental examples of the present invention do not describe the results of the films obtained through the examples 1 to 5, respectively, the results exist within a signification level. Also, the average phase of the results is shown by the results of the package according to the present invention, which are shown in FIG. 4 to FIG. 7 and Table 6 to Table 7.

### INDUSTRIAL APPLICABILITY

The films according to the present invention can be useful for a package for packaging fermented food, such as Kimchi, etc., or fresh food, such as vegetables, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fresh or fermentation food packaging film whose average pore size is 0.01-2 μm and whose porosity is 10-80%, wherein the film is manufactured from pure crystalline polymer without addition of inorganic compounds or organic compounds for pore formation, so as to impart microporousness thereto by a dry stretching method which does not use an organic solvent and a solvent.

2. The film according to claim 1, wherein the film is 15-200 μm in thickness.

3. The film according to claim 1, wherein the film is manufactured by the steps of:
manufacturing an unstretched film as the pure crystalline polymer is extruded without addition of inorganic and organic particles, such as stabilizer, antioxidant, or dispersant;
crystallizing the unstretched film by cooling and forming fibrous pores by a physical stretching process; and
performing a heat process.

4. The film according to claim 1, wherein the crystalline polymer is one or more than one polyolefin group resins selected among from high-density polyethylene (HDPE), low-density polyethylene (LDPE), linear low-density polyethylene (LLDPE), high molecular weight polyethylene (HMW-PE), ultra high molecular weight polyethylene (UHMW-PE) and polypropylene (PP).

5. A polyolefin group film for packaging fresh or fermentation food, which is manufactured as parts of the fresh or fermentation food packaging film according to claim 1 are stuck to each other by heat.

6. A package for packaging fresh or fermentation food, wherein the package includes at least one or more than one layer of the fresh or fermentation food packaging film according to claim 1.

7. A package for packaging fresh or fermentation food, wherein the package includes at least one or more than one fold of the polyolefin group film according to claim 5.

8. A container for packaging fresh or fermentation food, wherein the container is formed as the fresh or fermentation food packaging film according to claim 1 is adapted to a lid.

9. A container for packaging fresh or fermentation food, wherein the container is formed as the polyolefin group film according to claim 5 is adapted to a lid.

10. The film according to claim 3, wherein the crystalline polymer is one or more than one polyolefin group resins selected among from high-density polyethylene (HDPE), low-density polyethylene (LDPE), linear low-density polyethylene (LLDPE), high molecular weight polyethylene (HMW-PE), ultra high molecular weight polyethylene (UHMW-PE) and polypropylene (PP).
